(19) United States
(12) Patent Application Publication
(10) Pub. No.: US 2018/0267695 A1
(43) Pub. Date: Sep. 20, 2018

(54) LAUNCHING UNIVERSAL PLATFORM APPLICATION SECONDARY VIEW ON DESIGNATED DISPLAY

(71) Applicant: MICROSOFT TECHNOLOGY LICENSING, LLC, Redmond, WA (US)

(72) Inventors: Kishore Kumar PESHKAR, Redmond, WA (US); David C. TSE, Kirkland, WA (US)

(73) Assignee: MICROSOFT TECHNOLOGY LICENSING, LLC, Redmond, WA (US)

(21) Appl. No.: 15/495,447

(22) Filed: Apr. 24, 2017

Related U.S. Application Data
(60) Provisional application No. 62/471,327, filed on Mar. 14, 2017.

(51) Int. Cl. G06F 3/0484; G06F 3/14; G06F 9/44

(52) U.S. Cl. CPC G06F 3/04845; G06F 9/4443; G06F 3/1454

(57) ABSTRACT

Universal platform applications, while advantageous and efficient, have inherent limitations, including an inability to manage multiple views on multiple display devices. According to embodiments, such management may be facilitated by packaging a universal platform application with a desktop application to launch a universal platform application secondary view on a designated display device. The universal platform application may invoke an application service hosted by the desktop application, generate a main view and a secondary view for display on a first display device, and transmit a request to the desktop application, where the request includes information associated with the secondary view and a designated display device identifier. Upon receiving a confirmation from the desktop application of a move of the secondary view from the first display device to a second display device associated with the designated display device identifier, the universal platform application may control presented content on the secondary view.

### CROSS-REFERENCE TO RELATED APPLICATION

This application claims the benefit under 35 U.S.C. § 119(e) of U.S. Provisional Patent Application No. 62/471,327 filed on Mar. 14, 2017. The U.S. Patent Application is herein incorporated by reference in its entirety.

### BACKGROUND

Universal platform applications, which are part of a platform-homogeneous application architecture, may be executed on a number of operating systems, operating system versions, and/or devices without a need for customization or different versions of the application. Despite advantages and efficiencies of universal platform applications, such programs may also be associated with inherent limitations, such as an inability to manage multiple views on multiple display devices.

Meeting room management applications provide management of meetings in conjunction with ancillary devices, such as displays and audio systems within a meeting space, and client devices associated with attendants. Meeting room applications may be provided as universal platform applications, but needs such as managing multiple views on multiple display devices may present a challenge in such configurations.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to launching a universal platform application secondary view on a designated display device. An example method according to embodiments may include invoking, at a universal platform application, an application service hosted by a desktop application, generating a view for display on a first display device, transmitting a request to the desktop application, where the request includes information associated with the generated view and a designated display device identifier, and controlling presented content on the generated view upon receiving a confirmation from the desktop application of a move of the generated view from the first display device to a second display device associated with the designated display device identifier.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example environment for launching a universal platform application secondary view on a designated display device;

FIG. 2 includes a display diagram that conceptually illustrates a universal platform application and a desktop application packaged together for launching a universal platform application secondary view on a designated display device;

FIGS. 3A-3C include display diagrams that conceptually illustrate launching of a universal platform application secondary view on a designated display device;

FIG. 4 is a networked environment, where a system according to embodiments may be implemented;

FIG. 5 is a block diagram of an example communal meeting device, which may be used to execute a universal platform application and a desktop application to launch a universal platform application secondary view on a designated display device; and

FIG. 6 includes a logic flow diagram that illustrates a process for launching a universal platform application secondary view on a designated display device, according to at least some embodiments disclosed herein.

### DETAILED DESCRIPTION

As briefly described above, embodiments may be provided to launch a universal platform application secondary view on a designated display device. According to some examples, a universal platform application may be capable of generating more than one view, but not capable of controlling where the views are to be displayed. A desktop application packaged together with the universal platform application may host an application service for the universal platform application. The universal platform application may invoke the application service, generate a view on a first display device, and transmit a request to the desktop application, where the request includes generated view information and a designated display device identifier. Upon being invoked by and receiving the generated view information and designated display device identifier from the universal platform application, the desktop application may move the generated view from the first display device to a second display device associated with the designated display device identifier. The desktop application may then optionally enlarge, reduce, or otherwise adjust a size of the generated view on the second display device.

A universal platform application, as used herein, refers to an application that is part of a platform-homogeneous application architecture. Thus, a universal platform application may be executed on a number of operating systems, operating system versions, and/or devices without a need for customization or different versions of the application. For example, the same universal platform application may be installed and executed on a desktop platform and a mobile platform. Some universal platform applications may not indicate having been written for a specific operating system or platform in their manifest build; instead, they may target one or more device families, such as a PC, smartphone, tablet, or gaming systems. These extensions may allow the application to automatically utilize the capabilities that are available to the particular device it is currently running on. The platform-agnostic nature of these applications may allow enhanced user experience aspects in addition to efficiency and reduced complexity. For example, a universal platform application executed on a smartphone may start behaving the way it would if it were running on a PC when the smartphone is connected to a desktop computer or a suitable docking station. On the other hand, being platform agnostic may mean for some of these applications limitations over platform-specific applications. For example, a number and type of Application Programming Interfaces (APIs) available in the application may be limited. Thus, a functionality of a universal platform application may also be subject to constraints based on its design such as the ability to launch and manage multiple views on different display devices.

Compared to universal platform applications, desktop applications, as referred to herein, are typically platform-specific such as operating system, operating system version, device, etc. While their specificity may make it more difficult to manage desktop applications on different devices or operating systems, it may also provide them with a higher degree of freedom with respect to functionality. Operating system or device specific APIs may be provided in desktop applications, for example. Thus, desktop applications may lend themselves more toward certain functionality. For example, functionality that is associated with monitoring and reacting to events that happen at operating system or hardware level. Following the example provided above, a desktop application may be configured to move a universal platform application launched secondary view to a designated display device and adjust its size if desired.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can, for example, be implemented via one or more of a volatile computer memory, a non-volatile memory, a hard drive, a flash drive, a floppy disk, or a compact disk, and comparable hardware media.

Throughout this specification, the term “platform” may be a combination of software and hardware, components for executing universal platform applications and desktop applications. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

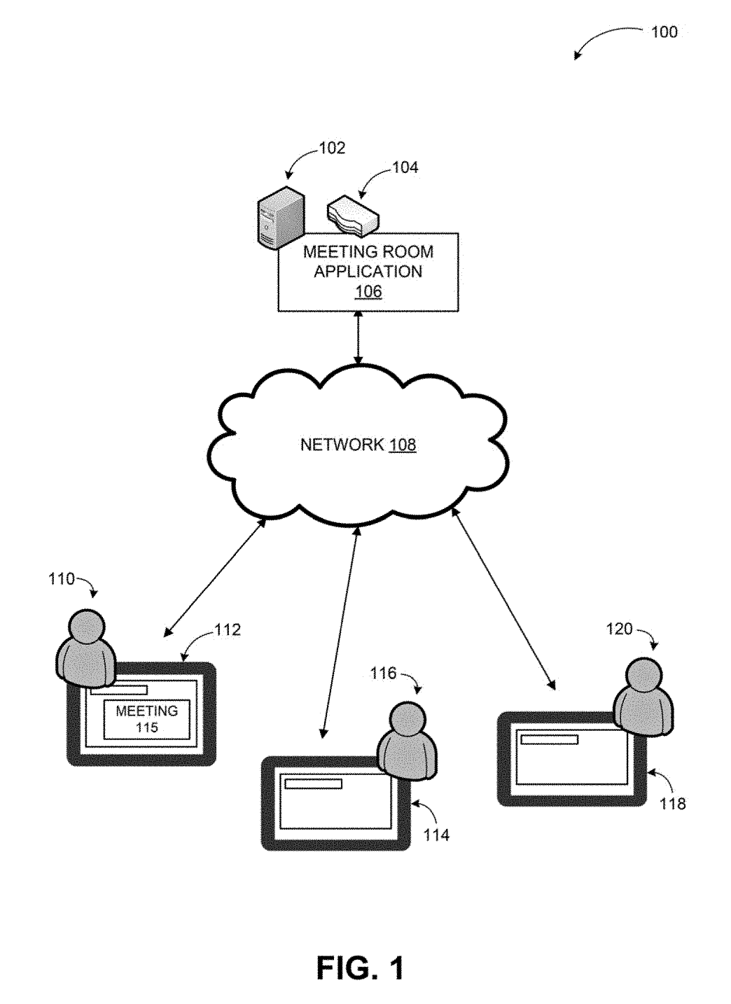

FIG. 1 illustrates an example environment for launching a universal platform application secondary view on a designated display device, according to at least some embodiments disclosed herein.

As illustrated in a diagram 100, an example system may include a meeting room management application 106 executed on a server 102, a communal meeting device 104, or other similar computing device. The communal meeting device 104 may be a special purpose device associated with one or more meeting spaces that is configured to manage meetings and ancillary devices, such as display or audio devices, in the meeting spaces. In some examples, the meeting room management application 106 may be configured to intemperate with various applications to allow attendants (e.g., attendants 110, 116, and 120) to participate in a meeting 115, provide content to be presented in the meeting, control ancillary devices in the meeting space, and perform other meeting related activities. The various applications may be thick (locally installed) or thin (browser) applications executed on client devices 112, 114, and 118, respectively. The interoperation may include exchange of data over one or more networks, such as network 108.

The network 108 may comprise any topology of servers, clients, Internet service providers, and communication media. In some examples, the applications executed on the client devices 112, 114, and 118 may include productivity applications, such as a presentation application, a word processing application, a communication application, a spreadsheet application, or a meeting application.

A universal platform application may generate a main view and a secondary view for display on a first display device. As discussed above, the universal platform application alone may not be capable of launching the secondary view to a different display device. Instead, the universal platform application may launch the secondary view to the same display device as the main view. For example, the meeting room management application 106, a universal platform application, may generate and provide for display a main view associated with general controls for a meeting space on a first display device, such as a laptop computer. The meeting room management application 106 may then generate a secondary view that may be launched to present meeting content for an initiated or ongoing meeting. A preferred configuration to display the secondary view with the meeting content presentation may be through a different, larger display device in the meeting space, such as a screen mounted onto one or more walls within the meeting space. However, this display may not be enabled by the limitations of the meeting room management application 106.

According to some embodiments, the meeting room management application 106, may be provided as a package with a corresponding desktop application that serves as a hosting service to the meeting room management application 106. The desktop application may be invoked by the meeting room management application 106 such that the secondary view generated by the meeting room management application 106 may be moved from the first display device to an available, second display device and adjusted in size on that second display if desired.

As previously discussed, despite advantages and efficiencies of universal platform applications, these programs may also be associated with inherent limitations, such as an inability to manage multiple views on multiple display devices. For example, meeting room applications may be provided as universal platform applications, but management of multiple views on multiple display devices may present a challenge in such configurations. According to the above-described embodiments, such management of multiple views on multiple display devices may be facilitated by packaging a universal platform application and a desktop application together to launch a universal platform application secondary view on a designated display device. Packaging the universal platform application and the desktop application together may, among others other things, improve computing device performance, reduce processing and network bandwidth usage associated with a computing device, reduce energy savings associated with the computing device, and improve user interaction by allowing users to launch and view a secondary view on a different display device through the universal platform application.

Embodiments address a need that arises from very large scale of operations created by networked computing and cloud based services that cannot be managed by humans. The actions/operations described herein are not a mere use of a computer, but address results of a system that is a direct consequence of software used as a service such as management of meetings through universal platform applications.

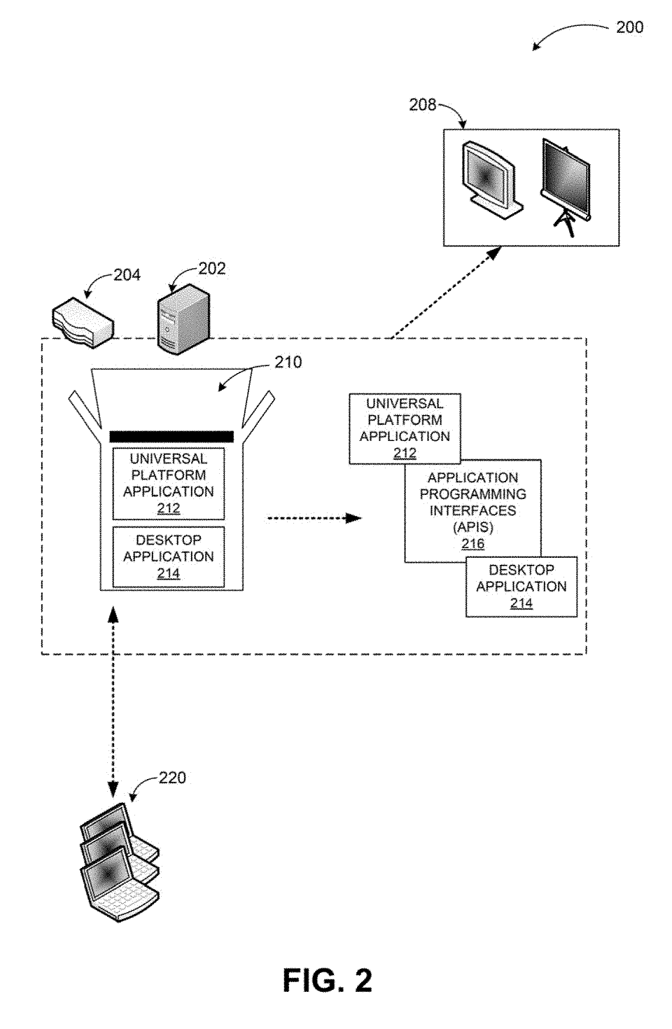

FIG. 2 includes a display diagram that conceptually illustrates a universal platform application and a desktop application packaged together for launching a universal platform application secondary view on a designated display device, according to at least some embodiments disclosed herein.

As shown in diagram 200, a universal platform application 212 may be packaged together with an associated desktop application 214 in an application package 210. In an example embodiment, the application package 210 may be for a meeting room management application executed on a server 202 or a communal meeting device 204. The meeting room management application may be configured to facilitate meetings in a meeting space in conjunction with a meeting service, for example. Among other tasks, the meeting room management application may control ancillary devices in the meeting space, allow attendants to connect to the meeting through their client devices, and others. The ancillary devices may include audio components, printers, lighting, and display devices 208. The display devices 208 may include a wall projection system, a screen mounted onto one or more walls within the meeting room, an interactive floor display, an interactive window display, or an interactive wall display, among other examples. Once installed from the application package 210, the universal platform application 212 may include a further of application programming interfaces (APIs) 216 through which it may communicate with the desktop application 214 and other devices/applications (e.g., client devices 220).

In some embodiments, the desktop application 214 may host an application service for the universal platform application 212. During its launch, the universal platform application 212 may initialize the application service and use the APIs 216 to send requests to and receive responses from the desktop application 214. The universal platform application 212 may generate a main view and a secondary view for display on a first display device. The main view may be associated with general controls and the second view may be created in response to a user action or a state change in the universal platform applications' processes, for example. Upon creating the secondary view, the universal platform application may invoke the application service at the desktop application and provide information associated with secondary view along with a designated display device identifier. The secondary view information may include a size of the secondary view and an instruction to adjust the size of the secondary view. The instruction may include to enlarge the size of the secondary view to a full screen mode, reduce the size of the secondary view, or otherwise adjust the size of the secondary view based on a parameter of the second display device. The designated display device identifier may be selected based on available display devices other than the first display device identified by the desktop application.

Upon receiving the secondary view information and designated display device identifier from the universal platform application 212, the desktop application 214 may move the secondary view from the first display device to a second display device associated with the designated display device identifier. The universal platform application 212 may continue controlling the content of the secondary view (as well as when to close it), but does so on the second display device. The desktop application 214 may then optionally adjust the size of the secondary view displayed on the second display device based on the instructions provided within the secondary view information of the request.

In an example scenario, the meeting room management application (the universal platform application 212) may generate a main view and a secondary view. The main view may be associated with general controls for a meeting, and the secondary view may be a content presentation associated with the meeting. The main view and secondary view may be generated and managed by the meeting room management application for display on a tablet device. The meeting room management application may transmit a request to the desktop application 214 for the secondary view to be moved from the tablet device to a wall display in the meeting space. Upon moving the secondary view to the wall display, the desktop application 214 may change it to full screen so that attendants in the meeting space can view the presented content in large format on the wall display. The meeting room management application may then still control the content presentation on the secondary view. Meanwhile, the main view may remain on the original tablet device. In some examples, the main view may be brought to the foreground on the original tablet device and enlarged to a full screen mode.

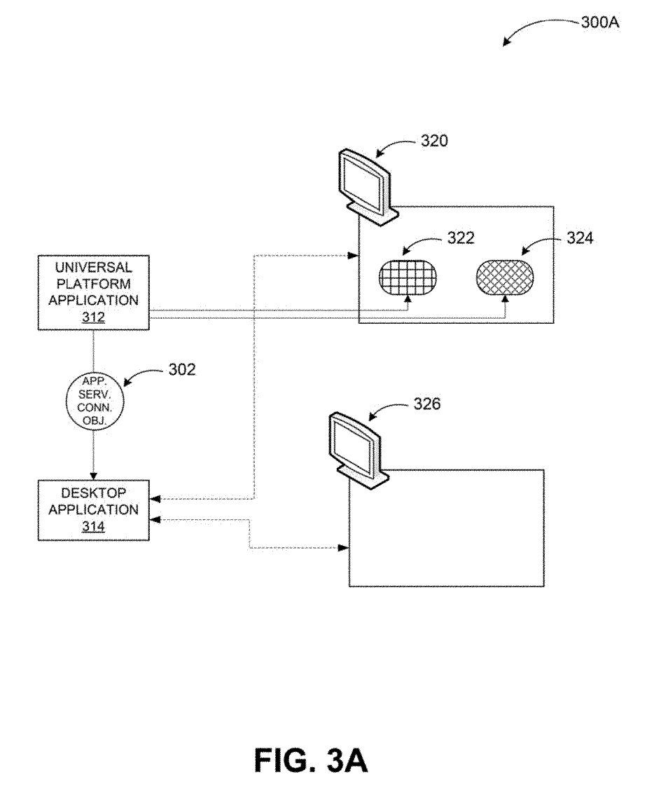

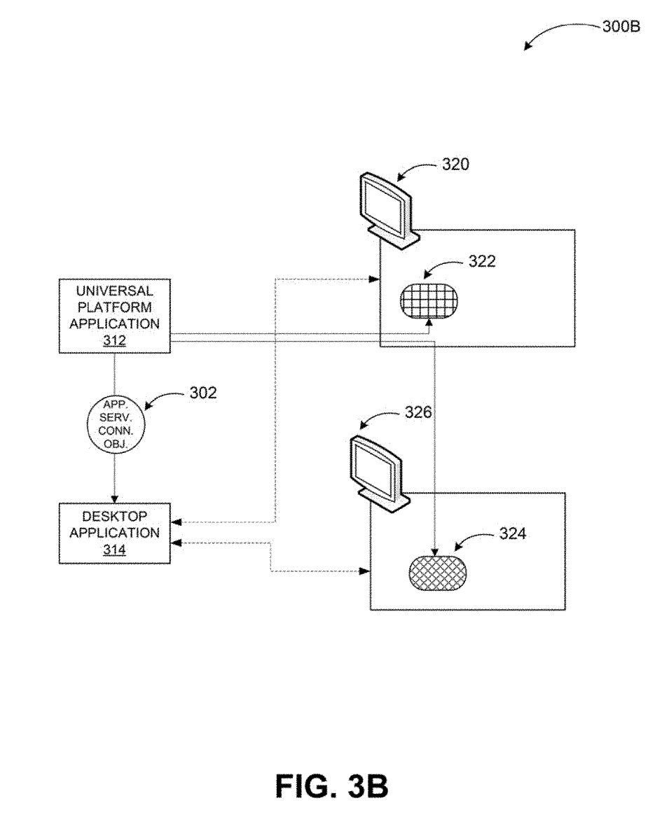

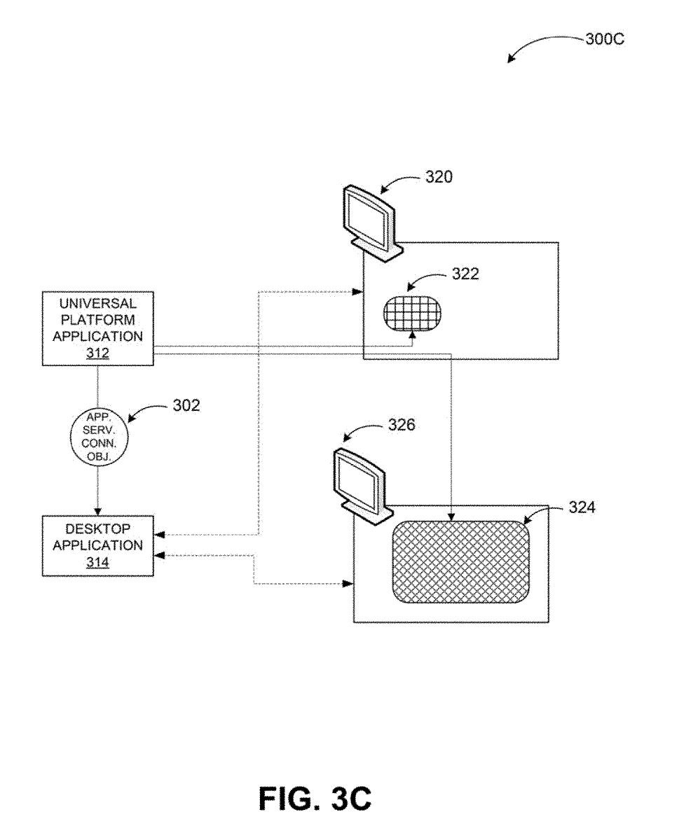

FIGS. 3A-3C include display diagrams that conceptually illustrate launching of a universal platform application secondary view on a designated display device, according to at least some embodiments disclosed herein.

Diagram 300A of FIG. 3A shows launching of views by a universal platform application. The universal platform application 312 may launch a main view 322 on a first display device 320. This may be followed by launching of a secondary view 324. As universal platform applications are typically not capable of controlling which display device to display their views on, both the main view 322 and the secondary view 324 may be placed (adjacent or overlapping) on the first display device 320. In some examples, the universal platform application 312 may communicate with an associated desktop application 314 via an application service connection object 302 and provide information associated with the secondary view 324 (e.g., a size and/or instructions to adjust the size of the secondary view 324) and a designated display device identifier. The desktop application 314 may be capable of identifying available display devices (e.g., the first display device 320 and a second display device 326). The universal platform application 312 may select the designated display device identifier such that it corresponds to one of the identified, available display devices.

Diagram 300B of FIG. 3B shows a next phase in the example process, where the desktop application 314 may receive a request transmitted by the universal platform application 312 to move the secondary view 324 to the second display device 326. The request may include secondary view information, such as the size of the secondary view 324, and a designated device identifier associated with the second display device 326 to indicate which available device to move the secondary view 324 to.

Diagram 300C of FIG. 3C shows an optional operation, where the desktop application 314 may enlarge the secondary view 324 on the secondary display device 326 to a full screen mode based on instructions within the secondary view information included in the request transmitted by the universal platform application 312. In other examples, the moved secondary view 324 may be reduced or adjusted to other parameters depending on the second display device 326 and/or the instructions/request from the universal platform application 312. In further examples, the main view 322 may be brought to the foreground on the first display device 320 and enlarged to a full screen mode.

A textual scheme, a graphical scheme, an audio scheme, an animation scheme, a coloring scheme, a highlighting scheme, and/or a shading scheme may be employed to further enhance user interaction with a client interface of the universal platform application for launching of a universal platform application secondary view on a designated display device.

The examples provided in FIG. 1 through FIG. 3C are illustrated with specific systems, services, applications, views, and display devices. Embodiments are not limited to environments according to these examples. Embodiments for launching of a universal platform application secondary view on a designated display device may be implemented in environments employing fewer or additional systems, services, applications, views, and display devices. Furthermore, the example systems, services, applications, views, and display devices shown in FIG. 1 through FIG. 3C may be implemented in a similar manner with other values using the principles described herein.

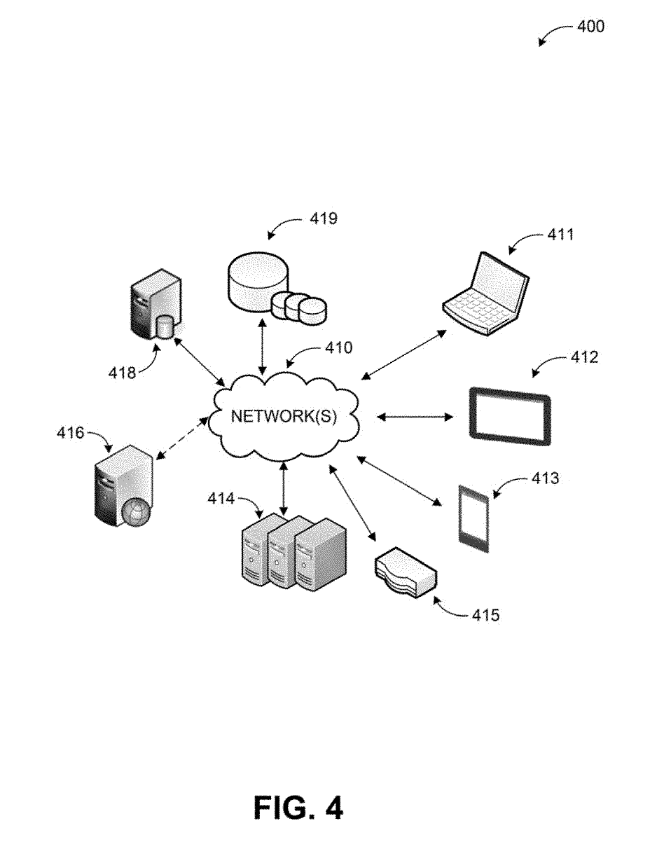

FIG. 4 is a networked environment, where a system according to embodiments may be implemented.

As shown in a diagram 400, universal platform service may be configured to launch a universal platform application secondary view on a designated display device. The universal platform service may be implemented in a networked environment over one or more networks, such as a network 410. Participants may access the universal platform service through locally installed client applications or thin (e.g., browser-based) client applications executed on a variety of computing/client devices (e.g., a laptop 411, a tablet 412, and/or a smartphone 413, etc.). Functionality within the universal platform service may be provided by one or more universal platform applications executed on servers 414, special purpose device 415, or processing server 416.

The servers 414, may include one or more processing server 416, where at least one of the one or more processing servers 416 may be configured to execute one or more applications associated with the universal platform service. The universal platform service may store data associated with a meeting in a data store 419 directly or through a database server 418.

The network 410 may comprise any topology of servers, clients, Internet service providers, and communication media. A system according to embodiments may have a static or dynamic topology. The network 410 may include multiple secure networks, such as an enterprise network, an unsecure network, or the Internet. The unsecure network may include a wireless open network. The network 410 may also coordinate communication over other networks, such as Public Switched Telephone Network (PSTN) or cellular networks. Furthermore, the network 410 may include multiple short-range wireless networks, such as Bluetooth, or similar ones. The network 410 may provide communication between the nodes described herein. By way of example, and not limitation, the network 410 may include wireless media. The wireless media may include, among others, acoustic media, RF media, infrared media, and other wireless media.

Many other configurations of computing devices, applications, engines, modules, data sources, and data distribution systems may be employed for launching of a universal platform application secondary view on a designated display device. Furthermore, the networked environments discussed in FIG. 4 are for illustration purposes only. Embodiments are not limited to the example applications, modules, engines, or processes.

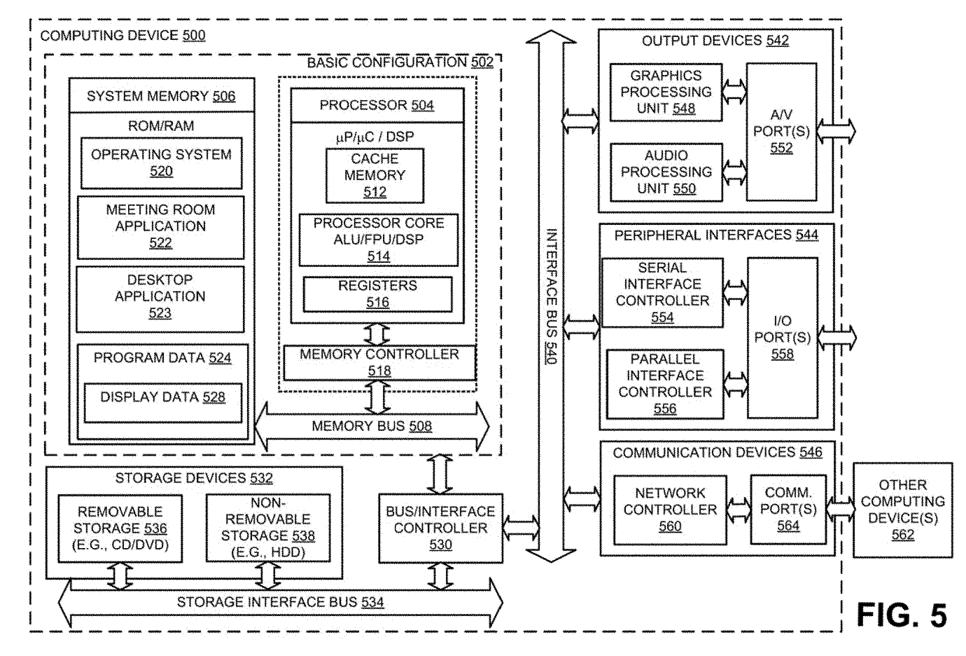

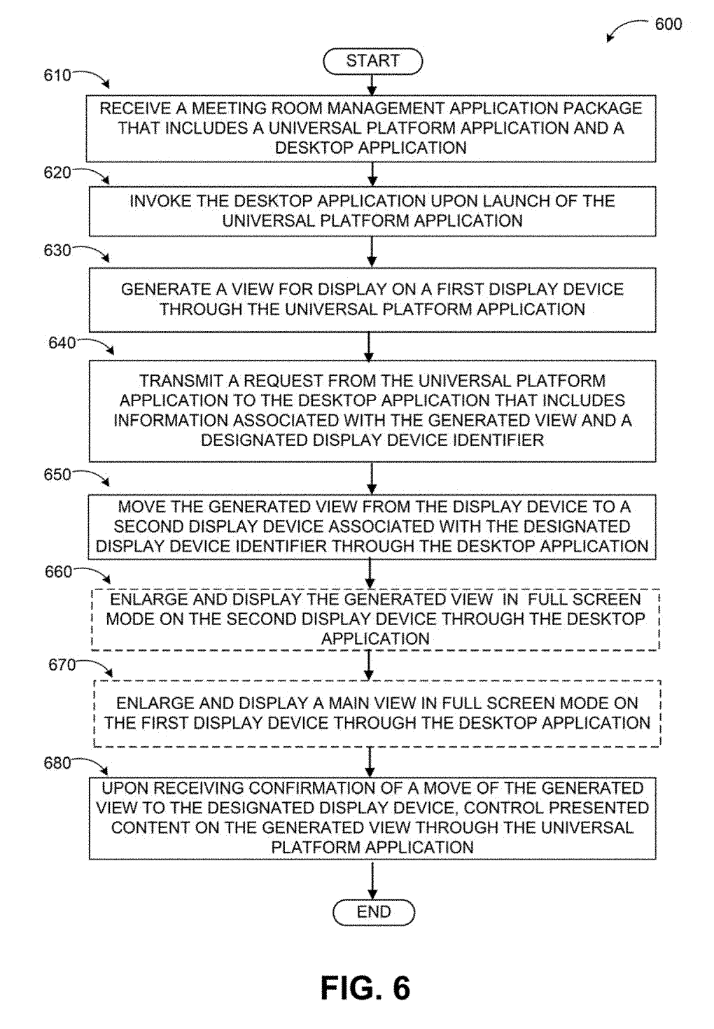

FIG. 5 is a block diagram of an example communal meeting device, which may be used to execute a universal platform application and a desktop application to launch a universal platform application secondary view on a designated display device, according to at least some embodiments described herein.

For example, a computing device 500 may be a special purpose device composed of generic and special purpose hardware and software components or a special purpose component integrated into a general purpose computing device. In an example basic configuration 502, the computing device 500 may include one or more processors 504 and a system memory 506. A memory bus 508 may be used for communicating between the processor 504 and the system memory 506. The example basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one more levels of caching, such as a level cache memory 512, one or more processor cores 514, and registers 516. The one or more processor cores 514 may (each) include an arithmetic logic unit (ALU), a floating point unit (FDU), a digital signal processing core (DSP Core), or any combination thereof. An example memory controller 518 may also be used with the processor 504, or in some implementations the example memory controller 518 may be an internal part of the processor 504.

Depending on the desired configuration, the system memory 506 may be of any type including but not limited to volatile memory (such as RAM) and non-volatile memory (such as ROM, flash memory, etc.), or any combination thereof. The system memory 506 may include an operating system 520, a universal platform meeting room management application 522, a desktop application 523, and program data 524. The universal platform meeting room management application 522 in conjunction with the associated desktop application 533 may be configured to launch a secondary view on a first display device and move it to a second display device. The desktop application 523 may be included in a universal platform meeting room management application package together with the universal platform meeting room management application 522. The program data 524 may include display data 528 (e.g., display characteristics associated with available displays).

The computing device 500 may have additional features or functionality, and additional interfaces to facilitate communications between the example basic configuration 502 and any desired devices and, interfaces. For example, a bus/interface controller 530 may be used to facilitate communications between the example basic configuration 502 and one or more data storage devices 532 via a storage interface bus 534. The data storage devices 532 may be one or more removable storage devices 536, one or more non-removable storage devices 538, or a combination thereof. Examples of the removable storage and the non removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interfaces 544, and an example communication device 546) to the example basic configuration 502 via the bus/interface controller 530. Some of the one or more output devices 542 may include a graphics processing unit 548 and an audio processing unit 550, which may be configured to communicate with various external devices, such as a display or speakers via one or more A/V ports 552. The one or more peripheral interfaces 544 may include a serial interface controller 554 or a parallel interface controller 556, which may be configured to communicate with external devices, such as input devices (e.g., a keyboard, a mouse, a pen, a voice input device, and/or a touch input device, etc.) or other peripheral devices (e.g., a printer and/or a scanner, etc.) via one or more I/O ports 558. The example communication device 546 may include a network controller 560, which may be arranged to facilitate communications with one or more other computing devices 562 over a network communication link via one or more communication ports 564. The one or more other computing devices 562 may include servers, computing devices, and comparable devices.

The network communication link may be one example of a communication media. The communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, the communication media may include wired media such as a wired network or direct-wired connection, and wireless media such as acoustic, radio frequency (RF), microwave, infrared (IR) and other wireless media. The term computer readable media, as used herein, may include both storage media and communication media.

Example embodiments may also include methods for launching of a universal platform application secondary view on a designated display device. These methods can be implemented in any number of ways, including the structures described herein. One such way may be by machine operations of devices of the type described in the present disclosure. Another optional way may be for one or more of the individual operations of the methods to be performed in conjunction with one or more human operators performing some of the operations while other operations may be performed by machines. These human operators need not be co-located with each other, but each can be only with a machine that performs a portion of the program. In other embodiments, the human interaction can be automated such as by pro-selected criteria that may be machine automated.

FIG. 5 includes a logic flow diagram that illustrates a process for launching of a universal platform application secondary view on a designated display device, according to at least some embodiments disclosed herein.

Process 600 may be implemented on a computing device, a server, or another system, such as a communal meeting device. An example computing device may include a communication interface, one or more sensors, a memory, and a processor. The communication interface may be configured to facilitate an exchange of data with other computing devices. The one or more sensors may be configured to detect an activity within a meeting room. The memory may be configured to store instructions. The processor may be coupled to the communication interface, the one or more sensors, and/or the memory, among other components.

Process 600 begins with operation 610, where the processor may be configured to receive a meeting room management application package that includes a universal platform application and the desktop application. At operation 520, the desktop application may be invoked upon launch of the universal platform application. Alternatively, the desktop application may be invoked each time a view is generated and maintained by the universal platform application.

At operation 630, the universal platform application may generate a view for display on a first display device. The view may be a secondary view, for example. The universal platform application may communicate with the desktop application through an application service connection of for the purposes of launching and managing the generated view. At operation 640, the universal platform application may transmit a request to the desktop application. The request may be to move the generated view from the first display device. The request may include information associated with the generated view and a designated display device identifier. In some examples, the desktop application may identify available display devices, and the designated display device identifier may be associated with one of those available display devices to which the generated view is desired to be moved to (e.g., a second display device).

Upon receipt of the request from the universal platform application, at operation 650, the desktop application may move the generated view to a second display device. Optionally, at operation 660, the desktop application may be configured to enlarge and display the generated view in a full screen mode on the designated display device. Alternatively, a size of the generated view may be reduced or otherwise adjusted based on a parameter of the designated display device. The size adjustment of the generated view may be based on the information associated with the generated view included within the request. Optionally, at operation 670, a main view may be enlarged and displayed in a full screen mode on the first display device once the generated view is moved.

At operation 680, upon receiving a confirmation from the desktop application of the move (and optional size adjustment) of the generated view from the first display device to the second display device associated with the designated display device identifier, the universal platform application may control presented content on the generated view.

The operations included in process 600 are for illustration purposes. Launching of a universal platform application secondary view on a designated display device may be implemented by similar processes with fewer or additional steps, as well as in a different order of operations using the principles described herein. The operations described herein may be executed by one or more processors operated on one or more computing devices, one or more processor cores, specialized processing devices, and/or, general purpose processors, among other examples.

According to some embodiments, means for launching of a universal platform application view on a designated display device are provided. Example means include invoking, at a universal platform application, an application service hosted by a desktop application, generating a view for display on a first display device, transmitting a request to the desktop application, where the request includes information associated with the generated view and a designated display device identifier, and upon receiving a confirmation from the desktop application of a move of the generated view from the first display device to a second display device associated with the designated display device identifier, controlling presented content on the generated view.

According to some examples, methods executed on computing devices for launching of a universal platform application view on a designated display device are provided. An example method includes invoking, at a universal platform application, an application service hosted by a desktop application, generating a view for display on a first display device, transmitting a request to the desktop application, where the request includes information associated with the generated view and a designated display device identifier, and upon receiving a confirmation from the desktop application of a move of the generated view from the first display device to a second display device associated with the designated display device identifier, controlling presented content on the generated view.

In other examples, the hosted service is invoked upon launch of the universal platform application or upon generating the view. The request may be transmitted and the confirmation may be received via an application service connection object stored by the universal platform application. The information associated with the generated view may include a size of the view. The information associated with the request may further include an instruction to adjust the size of the generated view on the second display device. The instruction to adjust the size of the generated view on the second display device may include to enlarge the size of the generated view to a full screen mode, reduce the size of the generated view, or adjust the size of the generated view based on a parameter of the second display device.

In further examples, a confirmation may be received from the desktop application that the size of the generated view has been adjusted on the second display device. The generated view may be a secondary view and upon receiving confirmation from the desktop application of a move of the secondary view, a main view may be brought to foreground on the first display device. The main view may be enlarged to a full screen mode on the first display device. The universal platform application and the desktop application may be packaged together prior to installation of the universal platform application on the computing device.

According to some embodiments, computing devices configured to launch a universal platform application view on a designated display device are described. An example computing device may include a communication interface configured to facilitate exchange of data with other computing devices and display devices, a memory configured to store instructions, and a processor coupled to the communication interface, the display devices, and the memory. The may be processor is configured to execute a universal platform application packaged together with a desktop application prior to installation of the universal platform application. The desktop application may be configured to identify available display devices. The universal platform application is configured to invoke an application service hosted by the desktop application, generate a view for display on a first display device, transmit a request to the desktop application, where the request includes information associated with the generated view and a designated display device identifier, and upon receiving a confirmation from the desktop application of a move of the generated view from the first display device to a second display device associated with the designated display device identifier, control presented content on the generated view.

In other embodiments, the information associated with the generated view may include a size of the generated view and an instruction to adjust the size of the generated view upon the move of the generated view from the first display device to the second display device. The instruction to adjust the size of the generated view includes to enlarge the size of the generated view to a full screen mode, reduce the size of the generated view, or adjust the size of the generated view based on a parameter of the second display device. The second display device is one of the available display devices identified by the desktop application.

According to some examples, communal devices configured to launch a universal platform application view on a designated display device are described. An example communal device may include a communication interface configured to facilitate exchange of data with computing devices and ancillary devices in a meeting space, a memory configured to store instructions, and a processor coupled to the communication interface, the ancillary devices, and the memory. The processor may be configured to receive a meeting room management application package that includes a universal platform application and a desktop application, invoke the desktop application upon launch of the universal platform application, identify available display devices through the desktop application, generate a view for display on a first display device through the universal platform application, transmit a request from the universal platform application to the desktop application, where the request includes information associated with the generated view and a designated display device identifier, move the generated view from the first display device to a second display device through the desktop application, and control presented content on the generated view through the universal platform application.

In other examples, the generated view may be a secondary view, and generation of the secondary view may be in response to a user action or a state change in processes of the universal platform application. The meeting room management application package may be configured to interoperate with other applications to enable users to participate in a meeting, provide content to be presented in the meeting, control the ancillary devices in the meeting space, and perform other meeting related activities. The universal platform application may comprise one or more application programming interfaces (APIs) through which the universal platform application communicates with the desktop application and the other applications.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for launching of a universal platform application view on a designated display device, the method comprising:
invoking, at a universal platform application, an application service hosted by a desktop application;
generating a view for display on a first display device;
transmitting a request to the desktop application, wherein the request includes information associated with the generated view and a designated display device identifier;
upon receiving a confirmation from the desktop application of a move of the generated view from the first display device to a second display device associated with the designated display device identifier, controlling presented content on the generated view.

2. The method of claim wherein invoking the application service hosted by the desktop application comprises invoking the hosted service upon launch of the universal platform application.

3. The method of claim 1, wherein invoking the application service hosted by the desktop application comprises invoking the hosted service upon generating the view.

4. The method of claim 1, further comprising:
transmitting the request and receiving the confirmation via an application service connection object stored by the universal platform application.

5. The method of claim 1, wherein the information associated with the generated view includes a size of the view.

6. The method of claim 5, wherein the information associated with the request further includes an instruction to adjust the size of the generated view on the second display device.

7. The method of claim 6, wherein the instruction to adjust the size of the generated view on the second display device includes to one of: enlarge the size of the generated view to a full screen mode, reduce the size of the generated view, and adjust the size of the generated view based on a parameter of the second display device.

8. The method of claim 6, further comprising:
receiving confirmation from the desktop application that the size of the generated view has been adjusted on the second display device.

9. The method of claim 1, wherein the generated view is a secondary view.

10. The method of claim 9, further comprising:
upon receiving confirmation from the desktop application of a move of the secondary view, bringing a main view to foreground on the first display device.

11. The method of claim 10, further comprising:
enlarging the main view to a full screen mode on the first display device.

12. The method of claim 1, wherein the universal platform application and the desktop application are packaged together prior to installation of the universal platform application on the computing device.

13. A computing device configured to launch a universal platform application view on a designated display device, the computing device comprising:
a communication interface configured to facilitate exchange of data with other computing devices and display devices;
a memory configured to store instructions; and
a processor coupled to the communication interface, the display devices, and the memory, wherein the processor is configured to execute:
a universal platform application packaged together with a desktop application prior to installation of the universal platform application, wherein
the desktop application is configured to identify available display devices; and
the universal platform application is configured to
invoke an application service hosted by the desktop application;
generate a view for display on a first display device;
transmit a request to the desktop application, wherein the request includes information associated with the generated view and a designated display device identifier; and
upon receiving a confirmation from the desktop application of a move of the generated view from the first display device to a second display device associated with the designated display device identifier, control presented content on the generated view.

14. The computing device of claim 13, wherein the information associated with the generated view includes a size of the generated view and an instruction to adjust the size of the generated view upon the move of the generated view from the first display device to the second display device.

15. The computing device of claim 14, wherein the instruction to adjust the size of the generated view includes to one of enlarge the size of the generated view to a full screen mode, reduce the size of the generated view, and adjust the size of the generated view based on a parameter of the second display device.

16. The computing device of claim 13, wherein the second display device is one of the available display devices identified by the desktop application.

17. A communal device configured to launch a universal platform application view on a designated display device, the computing device comprising:
a communication interface configured to facilitate exchange of data with computing devices and ancillary devices in a meting space;
a memory configured to store instructions; and
a processor coupled to the communication interface, the ancillary devices, and the memory, wherein the processor is configured to:
receive a meeting room management application package that includes a universal platform application and a desktop application;
invoke the desktop application upon launch of the universal platform application;
identify available display devices through the desktop application;
generate a view for display on a first display device through the universal platform application;
transmit a request from the universal platform application to the desktop application, wherein the request includes information associated with the generated view and a designated display device identifier;
move the generated view from the first display device to a second display device through the desktop application; and
control presented content on the generated view through the universal platform application.

18. The communal meeting device of claim 17, wherein the generated view is a secondary view, and generation of the secondary view is in response to a user action or a state change in processes of the universal platform application.

19. The communal meeting device of claim 17, wherein the meeting room management application package is configured to interoperate with other applications to enable users to participate in a meeting, provide content to be presented in the meeting, control the ancillary devices in the meeting space, and perform other meeting related activities.

20. The communal meeting device of claim 19, wherein the universal platform application comprises one or ore application programming interfaces (APIs) through which the universal platform application communicates with the desktop application and the other applications.
